(19) United States
(12) Patent Application Publication
(10) Pub. No.: US 2009/0031783 A1
(43) Pub. Date: Feb. 5, 2009

(54) DROP TEST APPARATUS

(76) Inventors: Shinji Fukushima, Ibaraki-ken (JP); Shuichi Kurahara, Ibaraki-ken (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/832,739

(22) Filed: Aug. 2, 2007

(51) Int. Cl. G01N 3/303

(52) U.S. Cl. 73/12.06

(57) ABSTRACT

Drop test apparatus, for performing a drop impact test by dropping an article to be tested on a landing surface in a free fall state and by colliding the article with the landing surface, is equipped with a holder for holding the article and an acceleration means for accelerating the holder. The holder with the article is accelerated in the dropping direction of the article by the acceleration means, and the article is released from the holder at the point when the holder is accelerated to a predetermined speed and is dropped to the landing surface. The reproducibility of the test can be enhanced due to an elimination of an unstable factor such as frictional resistance when the holder is dropped, and a higher test in a dropping height without scaling-up the apparatus can be achieved.

### TECHNICAL FIELD

This invention relates to the drop test apparatus utilized for the drop test in freely dropping an article, such as portable equipment, to evaluate their reliability.

### BACKGROUND OF THE INVENTION

Reliability to the dropping impact is strongly requested in portable equipments such as cellular phones and mobile type portable terminals that may happen while carrying. In manufacturers fabricating the portable equipments and parts thereof, therefore, the reliability to the dropping impact is evaluated by repeating the drop test, which evaluates the influence of the dropping impact, and is performed by colliding the portable equipment and the part thereof with the landing surface in the state of a free fall, and also the design data on the dropping impact tendency is obtained. In such drop test, it is usual for the manufacturers of the portable equipment to test the portable equipment as the test article, and, for the parts manufacturers, it is usual to test parts (for instance, circuit board etc.) for the portable equipment fixed to the package frame that imitates the package of the portable equipment as the test article.

The drop test apparatus utilized for the drop test is disclosed in the following patent documents, for example.

Patent Document 1: JP, 2003-502630, A

Patent Document 2: JP, 2003-344251, A

Patent Document 3: JP, 2002-174574, A

Patent Document 4: JP, 2002-372485, A

Patent Document 5: JP, 2002-318181, A

Patent Document 6: JP, 2000-55778, A

Patent Document 7: JP, H09-318484, A (1997)

In the above-mentioned drop test, it becomes especially important to secure the identity of the condition at each repeated test, that is, the reproducibility in the repetition of the tests. Various factors and events take part in reproducibility. The main factors and events that take part in reproducibility are the stability of the dropping posture of the test article, the stability of the free fall condition, and the rebound.

As to the stabilization of the dropping posture of the test article, there is a technology wherein the test article is kept to some holder, the holder with the test article is dropped in the free fall state and the test article is released from the holder immediately before the collision with the landing surface, shown in examples of the above-mentioned Patent Documents 1 to 7.

In these conventional methods wherein the test article in the holder is freely dropped, there is a problem to lose the stability of the free fall condition. For freely dropping the test article in the holder, the holder keeping the test article therein should be guided by a certain drop guide means. The frictional resistance will be caused between the drop guide means and the holder along with the guide of the holder by the drop guide means. The stability of the free fall condition will be lost as the frictional resistance changes easily by the variations of the lubricity of the lubricant used to decrease the frictional resistance which is influenced, for instance, by such as the temperature atmosphere of the test place, and hence such change of the frictional resistance brings the unstable factor in the state of the drop of the test article.

There is a problem in the conventional methods, too, that the enlargement of the drop test apparatus is not avoided. The drop guide means should be installed in the conventional drop test apparatus, and the drop guide means should be installed by height corresponding to the dropping height. The conventional drop test apparatus is in need of height corresponding to the dropping height, and hence the scaling-up in height of the apparatus is not avoided to correspond to a higher drop test.

In the drop test, it is desired to prevent the rebound of the test article effectively. The rebound is an event that repeats the collision after the test article that collides with the landing surface leaps up in the reaction to the landing surface again. Such the rebound being a high uncertainty event repeatedly gives the uncertain impact to the test article, and hence becomes a factor to lose the reproducibility of the test.

Moreover, the rebound is a factor to obstruct the automation of the repetitive test. In the drop test, there are not few cases where the test is repeated for one test article, such as a circuit board, by every several thousand times. It is, therefore, desirable to repeat the test automatically without people' assistance. The rebound, however, is an obstruction factor as for the automation of the test. Thus, it is desirable to prevent the rebound effectively about the drop test apparatus. Concretely, it is desirable to ensure a single impact test that gives only one time of impact per drop of the article by preventing the rebound, and to attempt the automation of the test.

### SUMMARY OF THE INVENTION

The present invention is made under the background of the above-mentioned circumstances, and its first subject is to provide the drop test apparatus that enables the reproducibility of the test to be improved more by avoiding the participation of the unstable factor, such as the frictional resistance, which happens when the test article drops, and that enables to correspond to a drop test to be performed in higher dropping height without causing the scaling-up in height of the apparatus.

To provide the drop test apparatus that enables to surely perform the single impact test by the effective prevention of the rebound of the test article that collides with the landing surface, and that enables the automation of the repeat test is a second subject of this invention.

To accomplish the first subject mentioned above, in the present invention, the test article held in the holder is accelerated compulsively by an acceleration means toward the landing surface together with the holder, and, when the holder is accelerated to a predetermined speed, the test article is released from the holder and drops toward the landing surface. Concretely, the present invention is characterized by that, in the drop test apparatus performing a drop impact test by dropping the test article on the landing surface in the free fall state and by colliding the article with the landing surface, the holder for holding the article and the acceleration means for compulsively accelerating the holder are equipped, the holder with the article is accelerated in the dropping direction of the article by the acceleration means, and the article is released from the holder at the point when the holder is accelerated to a predetermined speed and is dropped to the landing surface.

According to the above-mentioned compulsion acceleration drop test, the reproducibility of the test can be improved by avoiding the participation of the unstable factor, such as the frictional resistance. Moreover, the compulsion acceleration drop test is effective also to the stabilization of the collision posture of the test article on the landing surface, and hence the reproducibility of the test can be improved. In addition, the compulsion acceleration drop test can adjust the drop speed, and, as a result, becomes possible to freely set the dropping height (a nominal dropping height). This enables the drop test from height more than the height of the drop test apparatus, and hence it becomes possible to correspond to a higher drop test without scaling-up the apparatus.

To accomplish the second subject mentioned above, in the present invention, the rebound of the test article can be prevented by holding the test article that collides with the landing surface while free falling and leaps up by the rebound prevention means in the air. Concretely, the present invention is characterized by that, in the drop test apparatus performing a drop impact test by dropping the test article on the landing surface in the free fall state and by colliding the article with the landing surface, the rebound prevention means having the grasp unit which grasps in the air the test article that collides with the landing surface and leaps up is equipped.

According to the above-mentioned rebound prevention means, the rebound impact to be caused by the collision of the leaped-up test article with the landing surface again is prevented, and thus a certain single impact test becomes possible. The holding of the test article in the air by the rebound prevention means can always let the test article take the state to land on a landing surface with constant posture. Therefore, it becomes easy to hold the test article again automatically by the holder, and a complete automation of the repeat test becomes possible.

In the above-mentioned drop test apparatus, it is preferable to accelerate compulsively the holder by transmitting the driving force for compulsive acceleration by the acceleration means through a timing belt. By doing like this, lightening of the accelerating force transmission element can be aimed at, and the inertia load of the accelerating force transmission element for the acceleration means can be reduced. The durability of the acceleration means can be raised by such reduction of the load, and the durability to bear for the drop test repeated, for example, by several thousand times units about one test article can be realized.

It is preferable to install, in the holder, the holding unit for holding the test article and the posture maintenance unit that maintains the posture of the test article on the occasion of a release of the test article from the holding unit. The posture of the test article can be kept when the holding unit releases the test article, and the reproducibility of the test can be improved more.

In the above-mentioned drop test apparatus, it is preferable to install an impact-absorbing means, in the grasp unit, for absorbing a shock of the test article on the occasion that the grasp unit grasps the leaped-up test article. It can be effectively controlled that the impact of the test article affects directly to the grasp unit on the occasion of the grasp of the test article, and can improve the durability of the holding unit greatly.

According to the compulsion acceleration drop test of the present invention, the reproducibility of the test can be improved by avoiding the participation of the unstable factor, such as the frictional resistance, which happens when the test article drops, and it becomes possible to correspond to a higher drop test without scaling-up the apparatus.

According to the drop test apparatus having a rebound prevention means of the present invention, the rebound of the test article colliding with the landing surface can be effectively prevented, and thus a certain single impact test becomes possible, and a complete automation of the repeat test becomes possible.

### BRIEF DESCRIPTION OF THE DRAWING

In the drawing:

FIG. 1 is a side view of a drop test apparatus of one embodiment of the present invention;

FIG. 2 is a view of the drop test apparatus shown in FIG. 1 looked from the upper side;

FIG. 3 is a view of the drop test apparatus shown in FIG. 1 looked from the left side of FIG. 1;

FIG. 4 is a view of the drop test apparatus shown in FIG. 3 looked from the left side of FIG. 3;

FIG. 5 is an enlarged view of a holder and a support arm;

FIG. 6 is a view of the holder and the support arm shown in FIG. 5 looked from the left side of FIG. 5;

FIG. 7 is a view of the holder and the support arm shown in FIG. 5 looked from the upper side of FIG. 5;

FIG. 8 is a perspective view of a main part of a holding unit and a posture maintenance unit;

FIG. 9 is an enlarged view of a halt receptacle section;

FIG. 10 is an enlarged view of a rebound prevention means;

FIG. 11 is a view of the rebound prevention means shown in FIG. 10 looked from the upper side of FIG. 10; and

FIG. 12 is a view of the rebound prevention means shown in FIG. 10 looked from the right side of FIG. 10.

### DETAILED DESCRIPTION

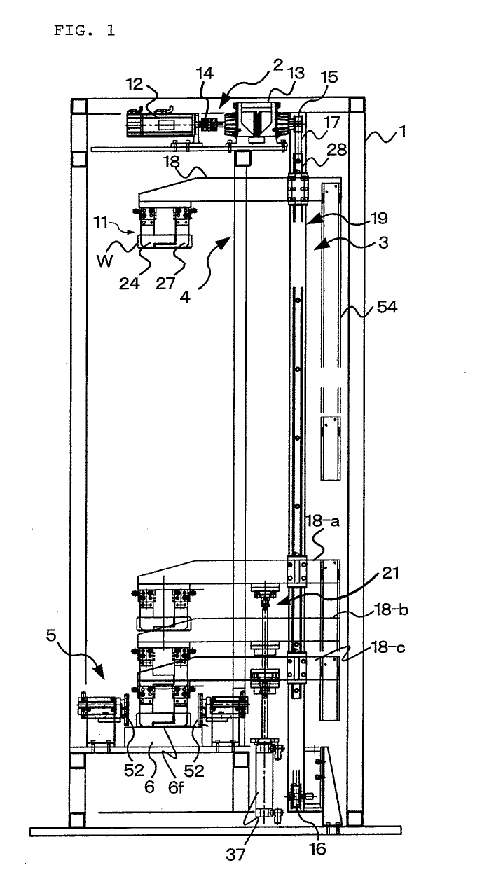

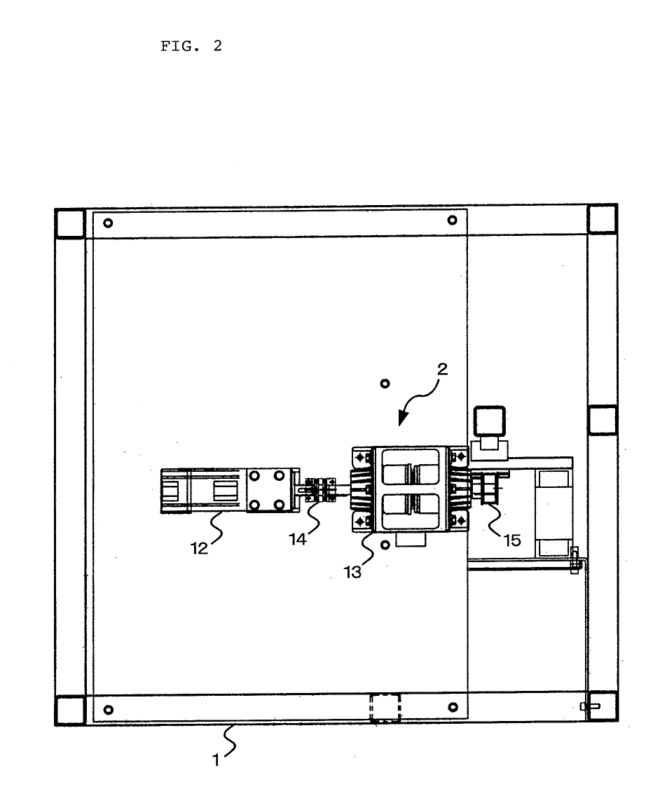

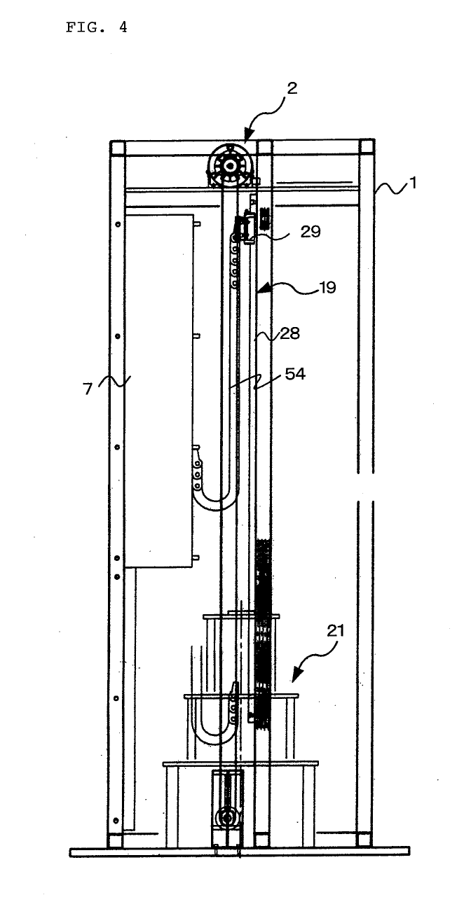

The embodiment of the present invention is described. Whole structure of one embodiment of the present invention is shown in FIG. 1 to FIG. 4. As shown in these FIG., the drop test apparatus is composed of, as the main element, acceleration means 2, accelerating force transmission 3, holding means 4, rebound prevention means 5, landing section 6, and control board 7 (FIG. 4), assembled in a frame body 1 formed in the shape of a vertically long and slim rectangular solid with steel materials. In FIG. 1 to FIG. 4, for avoiding complication, it is omitted to show a part of the components properly, and reference numerals are omitted arbitrarily.

The acceleration means 2 is assembled to the top part of the frame body 1, and works to compulsively accelerate the test article W held in the holder 11, which is one of the components of the holding means 4 explained later, toward the dropping direction of the test article up to the predetermined speed. The acceleration means 2 has a driving source 12 which generates a driving power for the compulsion acceleration. This driving source 12 is made for driving speed to be changed freely and to be able to correspond to the rapid stop. For instance, such driving source 12 is composed of a servomotor with the brake.

The acceleration means 2 has an electric brake 13 for stop rapidly the holder 11 when the holder 11 is accelerated to the predetermined speed and the test article is released at such speed to be dropped to the landing surface, in a word, a release-drop. This brake 13 is connected with driving source 12 through an electric clutch 14, and when release-drop, can be separated from driving source 12. By putting the clutch 14 between the brake 13 and the driving source 12, the regeneration current generated in the servomotor of the driving source 12 at the rapid stop of the holder 11 can be avoided effectively.

The accelerating force transmission 3, as shown in FIG. 1 and FIG. 4, is composed of a driving pulley 15 connected the output shaft of the acceleration means 2, a follower pulley 16 assembled on the bottom of the frame body 1, and a timing belt 17 connecting the driving pulley 15 and the follower pulley 16 so as to transmit the rotation drive power for the compulsive acceleration by the acceleration means 2 to the holding means 4. That is, the timing belt 17 receiving the driving power by the acceleration means 2 rotates in endless between the driving pulley 15 and the follower pulley 16, and, by this rotation of the timing belt 17, the driving power for the compulsive acceleration by the acceleration means 2 is transmitted to the holder 11. By transmitting driving power for the compulsion acceleration with timing belt 17, lightening of the accelerating force transmission 3 can be aimed at, and the inertia load of the accelerating force transmission 3 to the acceleration means 2 can be reduced. The durability of the acceleration means 2 can be raised by such reduction of the load, and the durability to bear for the drop test repeated, for example, by several thousand times units about one test article can be realized.

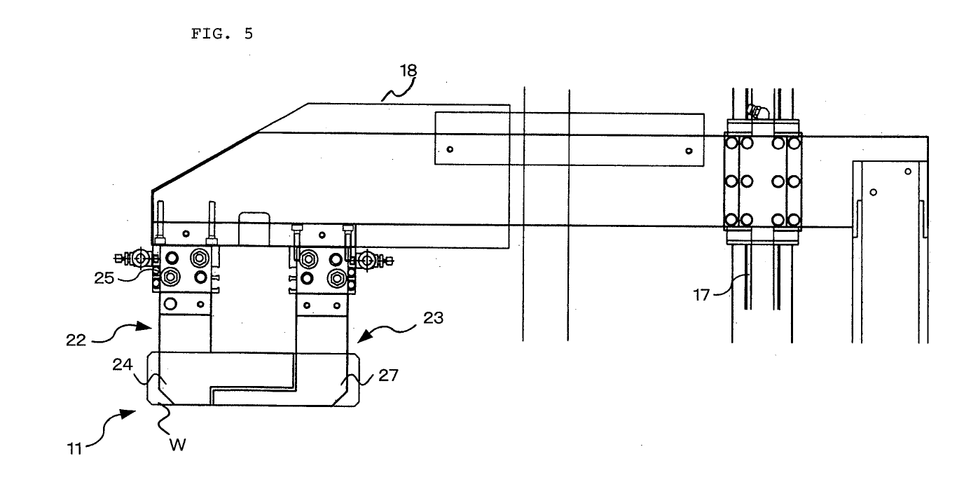

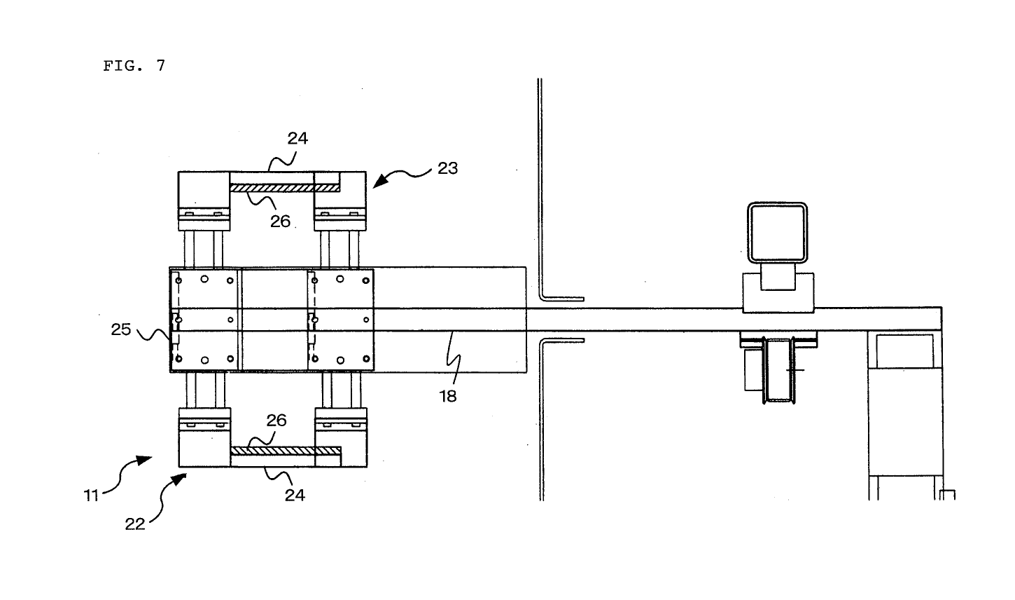

The holding means 4 is composed of, as the main element, the holder 11, a support arm 18 to support the holder 11, a rise-and-fall guide 19 to guide a vertical movement of the support arm 18, and a halt receptacle section 21 being a halt receptacle at the time of carrying out the rapid stop of the downward moving of the support arm 18, and it works so that the holder 11 held the test article dives down in response to the compulsive acceleration by the acceleration means 2 and releases the test article toward the landing surface 6f in the landing section 6 when accelerated up to the predetermined speed. This holding means 4 is shown in FIG. 5 to FIG. 7 with the enlarged view of the holder 11 and the support arm 18.

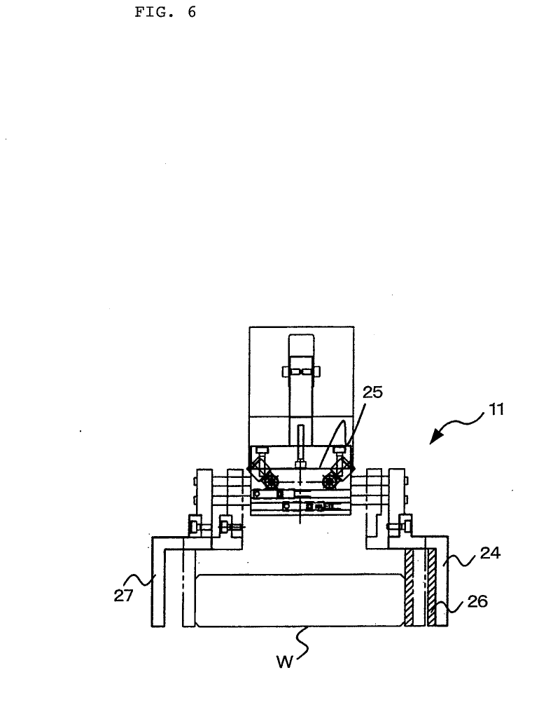

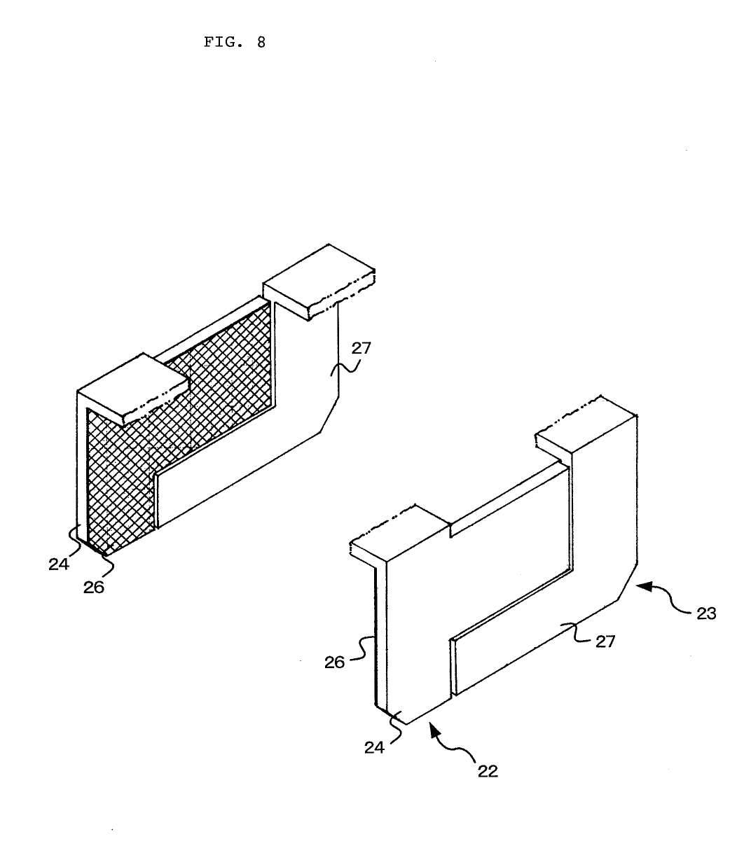

The holder 11 is installed in the point of the support arm 18, holds the test article, and is constituted so that the holding is opened when it is necessary. Concretely, the holder 11 is equipped with a holding unit 22 and a posture maintenance unit 23. The enlarged perspective view of the holding unit 22 and the posture maintenance unit 23 is shown in FIG. 8. The holding unit 22 has a pair of holding catches 24, 24 installed so as to be facing each other. The holding catches 24, 24 are connected to an actuator section 25 where an air actuator etc. is utilized, and are moved to back and forth toward the facing direction by the actuator section 25. By this back-and-forth movement, the distance between the holding catches 24, 24 is changed and hence the holding and releasing of the test article can be accomplished. The holding surfaces of the holding catches 24, 24 are made to have high coefficient of friction by putting high friction material 26, such as rubber, thereon, and hence the holding of the test article W becomes more stably. The posture maintenance unit 23 has a pair of posture maintenance catches 27, 27 installed so as to be facing each other like the holding unit 22. The posture maintenance catches 27, 27 are moved to back and forth toward the facing direction by the actuator section 25. This posture maintenance unit 23 functions to prevent the posture of the test article from collapsing when the holding unit 22 opens the holding of the test article, that is, to maintain the posture of the test article. That is, the posture maintenance catches 27, 27 of the posture maintenance unit 23 are combined with the holding catches 24, 24 so as to be a state along to the test article held in the holding unit 22 with a few clearance, and guide the test article so that the dropping posture of the test article is not collapsed when the test article is released from the holding unit 22 opened the holding and drops. The posture maintenance catches 27, 27 have guide surfaces with the small coefficient of friction. In FIG. 6, the status of the holding catches 24 and the posture maintenance catches 27 expanding and narrowing the space between them is shown.

The support arm 18 is formed in the shape of arm that is slender in the direction perpendicular to the running direction of the timing belt 17, is connected with the timing belt 17 in the middle part, moves vertically with endless rotation of the timing belt 17, and transmits the driving force for the compulsive acceleration of the acceleration means 2 to the holder 11 by the downward moving of the timing belt.

The rise-and-down guide 19 functions to stabilize the vertical movement of the support arm 18. The rise-and-down guide 19 is composed of the slide rail 28 prepared with the timing belt 17, and the slider 29 (FIG. 4) which slides by gearing with the slide rail 28, and the support arm 18 is connected with the slider 29.

The halt receptacle section 21 functions as a halt receptacle when the downward moving of the support arm 18 is rapidly stopped. Though the downward moving of the support arm 18 is rapidly stopped by the brake 13 while the holding of the test article by the holder 11 is opened, it is difficult to stop the support arm 18 accurately only by the braking power of the brake 13 at the position of predetermined height. Then, the support arm 18 can be stopped accurately at the predetermined height position, absorbing the kinetic energy by the halt receptacle section 21. As the support arm 18 can be stopped at the predetermined height position by the halt receptacle section 21, it becomes possible to make the height position where the holder is stopped and the holding of the test article by the holder 11 is opened, that is the open position, near the landing surface as much as possible. And hence the fall distance of the test article after it released from the holder 11 can be shortened as much as possible. This contributes to reduce the possibility of the change in the dropping posture of the released test article from the holder 11. Therefore, this brings the effect of improving the stability of the collision posture of the test article on the landing surface 6f and improving the reproducibility of the test. Moreover, the halt receptacle section 21 functions on making positioning of the holder 11 in the height direction to the test article in the landing state on the occasion that the test article is held by the holder 11 again after landing.

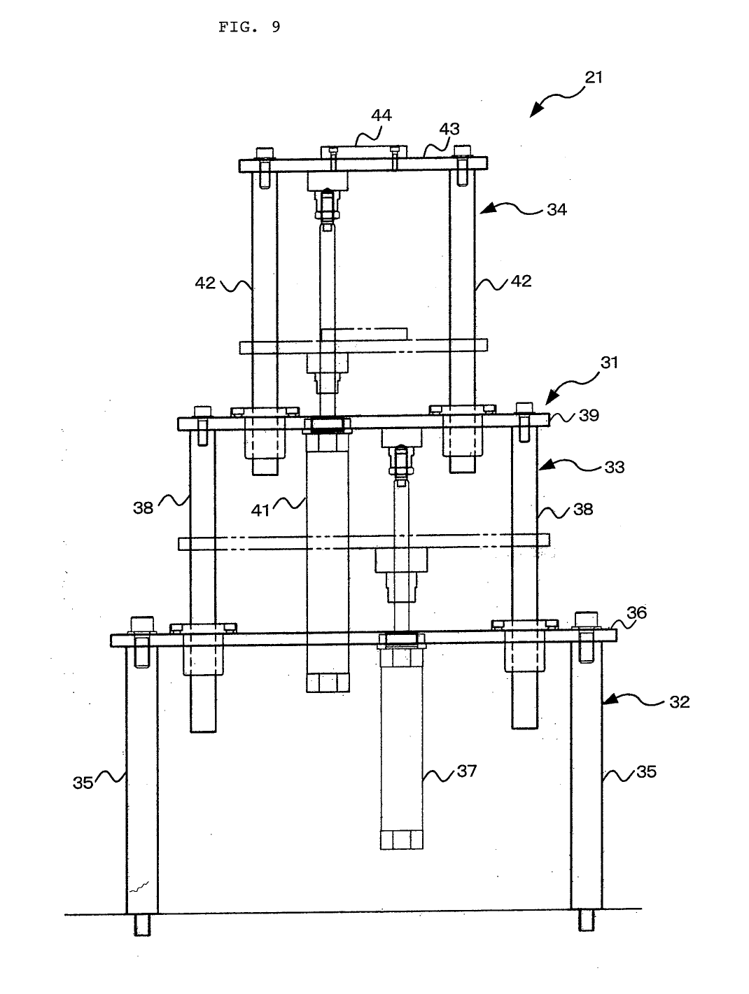

The halt receptacle section 21 is formed, as shown in FIG. 9, the tower-like frame body 31 as the frame. The tower-like frame body 31 is formed in the three-tiered structure of a base frame 32 as the 1^{st} layer, the 1^{st} movable frame 33 as the 2^{nd} layer piled on the base frame 32, and the 2^{nd} movable frame 34 as the 3^{rd} layer piled on the 1^{st} movable frame as 2^{nd} layer.

The base frame 32 is formed in the structure to support the top frame section 36 to the stanchions 35 installed on four corners, and is installed in the state of immobilization. The air cylinder 37 for positioning of the height of the support arm 18 is attached to the top frame section 36.

The 1^{st} movable frame 33 is formed in the structure to support similarly the top frame section 39 to the stanchions 38. The stanchions 38 are supported by the top frame section 36 of the base frame 32 so as to be able to slice in the vertical direction, and hence the 1^{st} movable frame 33 is possible to move vertically to the base frame 32. And while the piston rod of an air cylinder 37 is connected to the top frame section 39, the air cylinder 41 for kinetic energy absorption is attached.

The 2^{nd} movable frame 34 is formed in the structure to support similarly the top frame section 43 to the stanchions 42. The stanchions 42 are supported by the top frame section 39 of the 1^{st} movable frame 33 so as to be able to slide in the vertical direction, and hence the 2^{nd} movable frame 34 is possible to move vertically to the 1^{st} movable frame 33. The support arm receptacle section 44 for receiving the support arm 18 is formed on the top frame section 43, and the piston rod of an air cylinder 41 is connected to the top frame section 43.

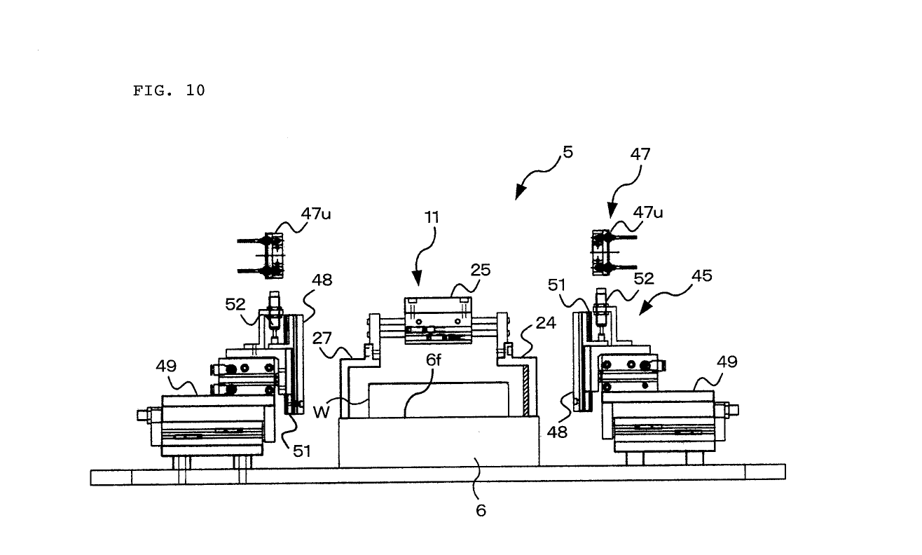

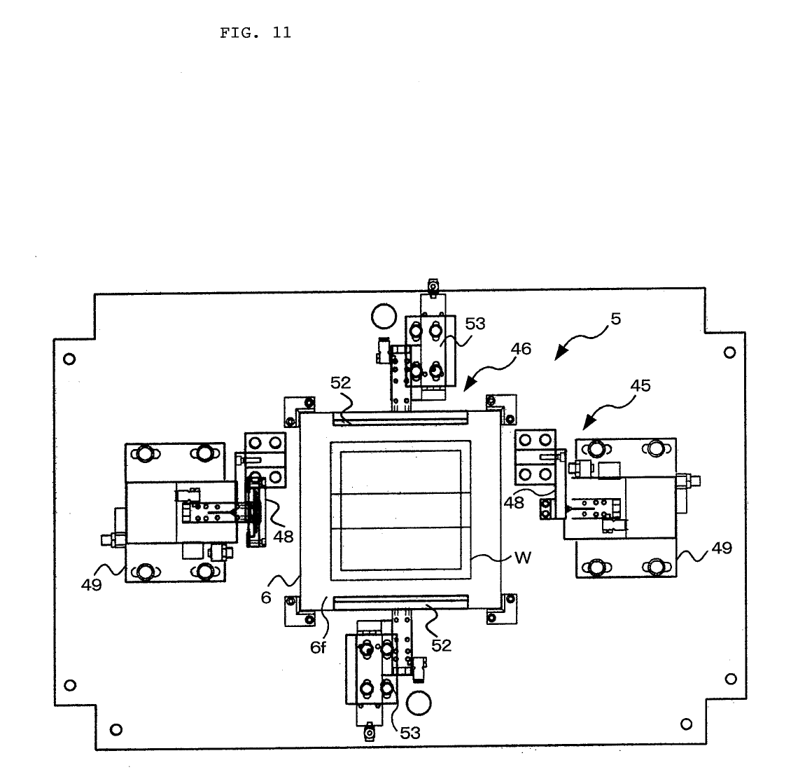

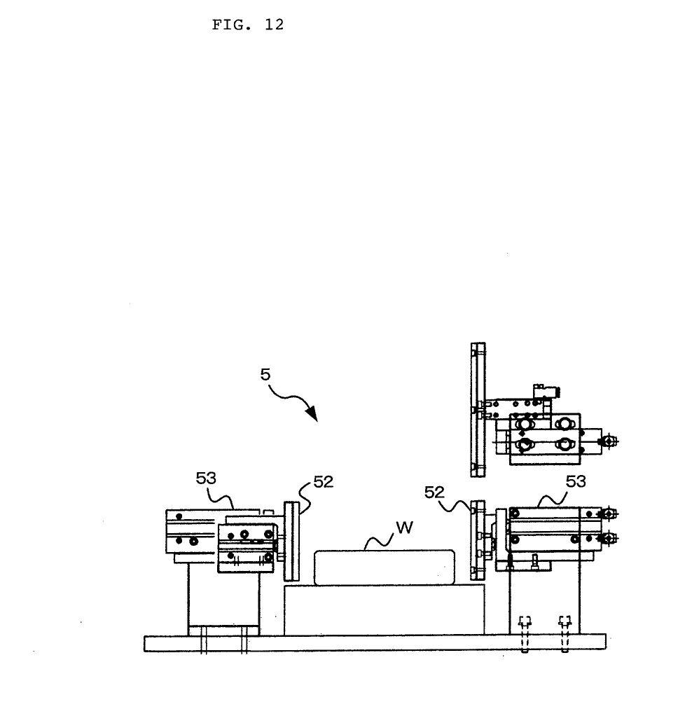

The rebound prevention means 5 prevents the test article colliding with landing surface 6f again and getting the rebound impact, by grasping the test article that collides with landing surface 6f and leaps up, in the air, before falling. FIG. 10 to FIG. 12 are enlarged views of the configuration of the rebound prevention means 5. As shown in these Figures, the rebound prevention means 5 is equipped with the speed-measuring instrument 47, while it is equipped with the main grasping unit 45 and the auxiliary grasping unit 46 (FIG. 11).

The main grasping unit 45 has a pair of grasping plates 48, 48 installed so as to be facing each other. Both grasping plates 48, 48 are connected to actuator sections 49, 49 where air actuators etc. are utilized, respectively, and are moved to back and forth toward the facing direction by the actuator sections 49, 49. By this back-and-forth movement, the distance between the grasping plates is changed and hence the grasping and releasing of the test article can be accomplished. Moreover, the grasping plates 48, 48 are connected to the actuator sections 49, 49 through the impact-absorbing means. The impact-absorbing means of this embodiment is constituted as a slide supporter 51. The slide supporter 51 is formed so as to allow the grasping plates 48 a free slide movement in the vertical direction. The slide supporter 51 has the impact-absorbing section 52 wherein the air cylinder etc. is utilized. The slide supporter 51 functions to letting the kinetic energy of leaping-up of the test article that affects to both grasping plates 48 and 48 go, when the test article collides with landing surface 6f, leaps up and is held in both grasping plates 48 and 48. The kinetic energy of leaping-up of the test article is missed by that the both grasping plates 48 and 48 slide up along with leaping-up movement of the test article and the impact-absorbing section 52 receives the slide movement. Thus, the main grasping unit 45 is saved from the impact raised at the grasping the test article, and hence the durability thereof is improved greatly.

The auxiliary grasping unit 46 has a pair of grasping plates 52, 52 installed so as to be facing each other. Both grasping plates 52, 52 are connected to actuator sections 53, 53, respectively, and are moved to back and forth toward the facing direction by the actuator sections. By this back-and-forth movement, the distance between the grasping plates is changed and hence the grasping and releasing of the test article can be accomplished. It is different from the main grasping unit 45 though is similar to main grasping unit 45 in these compositions in the point that slide supporter 51 is omitted. Such auxiliary grasping unit 46 owes the role to assist the grasping of the test article with the main grasping unit 45. The auxiliary grasping unit 46 grasps subsidiary the test article in the direction perpendicular to the grasping direction by the main grasping unit 45, so as to assist the grasping the test article with the main grasping unit 45 for making the posture of the test article constant when the grasping for the rebound prevention is opened and the test article is put on the landing surface 6f. Therefore, the grasping of the test article with the auxiliary grasping unit 46 delays some timing more than the grasping of the test article with the main grasping unit 45. In a word, the grasping with the auxiliary grasping unit 46 is held after the grasping of the test article with the main grasping unit 45. Therefore, since the auxiliary grasping unit 46 never receives the impact for grasping of the test article, the slide supporter 51 in the main grasping unit 45 becomes unnecessary.

The speed-measuring instrument 47 is constituted sensor units 47u opposing to each other, installed with plural photo sensors, and measures the landing speed of the test article. Information of the landing speed of the test article measured by the speed-measuring instrument 47 is given to the control system in the control board 7 described later. The control system calculates the timing of leaping-up after the collision of the test article with the landing surface 6f on the basis of the landing speed information, calculates the operation timing of the actuator sections 49 and 53 of the main grasping unit 45 and the auxiliary grasping unit 46 respectively from the timing of the leaping-up, and issues the operation signal to the actuator sections 49 and 53 according to the operation timing. Receiving the operation signal, the actuator sections 49 and 53 operate, and the test article is grasped with the main grasping unit 45 and the auxiliary grasping unit 46 respectively.

The landing section 6 is formed, assuming the landing impact condition in the falling of the actual usage of the portable equipment etc. to be tested, and by paving a concrete board etc. usually.

The control board 7 shown in FIG. 4 comprises the power supply circuit supplying the driving electric power to the operation elements in the acceleration means 2, the holding means 4 and the rebound prevention means 5, and the control system controlling the operation of the operation elements. The setting section is installed in the control board 7, and the driving speed of the driving source 12 in the acceleration means 2 can be set in the setting section, though illustration is omitted. The electric power cable and the signal cable are drawn from the control board 7 along with the flexible support member 54, such as CABLEVEYOR (registered trade mark of TSUBAKIMOTO CHAIN CO.), and the electric power and the operation signal can be supplied to operation elements.

The drop test utilizing the drop test apparatus is explained hereinafter. In the explanation, the circuit board installed in a portable equipment is used as the test article. In performing the drop test of the circuit board, the circuit board fixed to the package frame that imitates the package of the portable equipment serves as the actual test article. In case of the circuit board, it is usual that the drop test is repeated by every several thousand times for one test article.

In this drop test apparatus, the drop speed of the test article is compulsively accelerated by the acceleration means 2. Therefore, the adjustment of the drop speed can freely set up the dropping height. This enables the drop test from height more than the height of the drop test apparatus, and hence it becomes possible to correspond to a higher drop test without scaling-up the apparatus. By the introduction of this compulsive acceleration, the unstable factor in the drop, such as the frictional resistance, is excluded, and the reproducibility of the test is improved more.

Since the dropping height can be set up freely as mentioned above, the drop test starts from the setting of the dropping height if necessary with the control board 7. The dropping height is set as the driving speed of the driving source 12 in the acceleration means 2. The dropping height is set by setting the driving speed of the driving source 12 so that the drop speed at the time of landing of the test article which is released from the holder 11 and drops may become a speed of the free fall from the desired dropping height. Subsequently, the test article is held in the holder 11. The test begins when the start button (not shown) installed on the control board 7 etc. is pushed. When the test begins, the support arm 18 in an initial height position dives while receiving the compulsive acceleration with the acceleration means 2 through the timing belt 17, and the holder 11 opens the holding of the test article when the height position of the support arm reaches the predetermined open-position and the open-position detecting means (not shown) with photo sensors etc. detects it. It is desirable that the open-position is near the landing surface 6f as mentioned above, and, in the drop test apparatus of this embodiment, the position of the support arm 18-a shown in FIG. 1 is the open-position being the height of 250 mm from the landing surface 6f.

When the holder 11 opens the holding of the test article, the support arm 18 stops rapidly. Combining the braking with the brake 13 and the absorption of the kinetic energy of the support arm 18 by the halt receptacle section 21 perform the rapid stop as mentioned above, and, as a result, the support arm 18 can be stopped accurately at the predetermined height-position. The absorption of the kinetic energy of the support arm 18 by the halt receptacle section 21 is performed by receiving the downward force of the support arm 18 descending still by inertia even braking with the brake 13 by the support arm receptacle section 44 of the second movable frame 34 in the halt receptacle section 21 and adding the load to the air cylinder 41 for kinetic energy absorption through the second movable frame 34. In the drop test apparatus of this embodiment, the stop position of the support arm is shown as 18-b in FIG. 1, being somewhat under the open-position.

The test article released from the holder 11 drops from the open position aiming at the landing surface 6f. The drop is performed with the drop speed by a free fall from the open-position to the landing surface 6f added at the open position. That is, the free fall after the open position is performed with the momentum by the compulsive acceleration to the open position. Therefore, the maintenance accuracy of the dropping posture of the test article after the opening becomes high. This contributes to improving the reproducibility of the test by the improvement of the stability of the collision posture of the test article on the landing surface 6f as well as the stabilization of the fall posture of the test article by bringing the open-position mentioned above close to the landing surface 6f as much as possible. The stabilization of the dropping posture by the compulsive acceleration and the stabilization of the dropping posture by closing to the landing surface conjointly can make the collision posture on the landing surface 6f of the test article in the repeated test always constant, and hence the accuracy of the test can be improved greatly.

The test article that drops from the open-position collides with the landing surface 6f with the same drop speed as the drop speed in a free fall from the prescribed drop height. The drop speed at the collision is found from the measurement result of the drop speed at the opening by the speed-measuring instrument 47 in the rebound prevention means 5, and, based on the result, the grasping timing of the test article with the rebound prevention means 5 is set by the control system in the control board 7. The rebound prevention means 5 performs the above grasping actuation in response to the grasping command from the control system, and grasps in the air the test article that leaps up by the counteraction resulting from the collision with the landing surface 6f. The certain single impact test becomes possible by preventing the rebound impact of the test article resulting from the collision with landing surface 6f again, and the reliability of the test can be improved greatly. When the rebound prevention means 5 grasps the test article, the test article is calmly put on the landing surface 6f by slowly solving the grasp. By such operation of the rebound prevention means 5, the test article takes the landing state with the constant posture on the landing surface 6f. Therefore, it becomes possible that the holder 11 re-holds the test article automatically, and that the complete automation of the repeat test is attained.

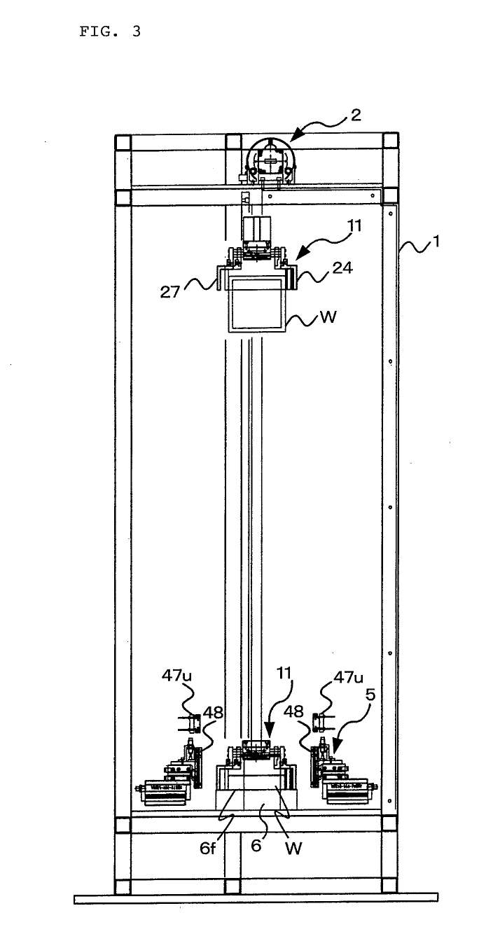

The re-holding of the test article on the landing surface by the holder 11 is performed by using the height direction positioning function of the holder 11 in the halt receptacle section 21. The height of the first movable frame 33 is adjusted by the air cylinder 37 for the height positioning in the halt receptacle section 21, and the height direction position of the holder 11 is suited to the test article W on the landing surface 6f, and then the test article is re-held in the holder 11. The height position of the support arm at the re-holding is shown as 18-c in FIG. 1. The state of the test article W re-held by the holder 11 is shown in FIG. 3. In FIG. 3, it is shown that the test article W held by the holder 11 at the initial height position of the support arm 18 is in the vertical state and the test article W on the landing surface is in the horizontal state. This is shown for the explanation of that the drop tests in the horizontal state and in the vertical state are possible. Thus, the holder re-holds the test article, and the support arm 18 returns to the initial height position and dives down from the initial height position. These operation repeats the predetermined times for the repeat test.

In the examination of circuit board, it is usual to monitor the conductivity for every collision on the landing surface 6f. The monitoring of the conductivity is performed in order to evaluate the drop-impact-proof of the circuit board by watching the change of the resistance of the solder portions and the internal contacts in the circuit board through the drop tests. For such the monitoring of the conductivity, the cable (not shown) etc. for the monitoring is arranged on the holder 11, and the monitoring is performed automatically through the cable etc.

Though the acceleration means is composed of the servomotor as the driving source in the above-mentioned embodiment, other modes are also possible to execute the present invention. For example, the acceleration means may be composed of the linear motor, or the air cylinder, especially rod-less air cylinder as the driving source. It is possible for those skilled in the art to put this invention into practice in various other manners.

1. A drop test apparatus for performing a drop impact test by dropping an article to be tested on a landing surface in a free fall state, comprising:
a holder for holding the test article; and
acceleration means for compulsively accelerating the holder;
wherein the holder holding the test article is accelerated toward a landing surface by the acceleration means; and the holder releases the test article at a predetermined speed.

2. A drop test apparatus according to claim 1, wherein a driving force for the compulsive acceleration in the acceleration means is transmitted through a timing belt.

3. A drop test apparatus according to claim 1, wherein the holder comprises a holding unit for holding the test article, and a posture maintenance unit for maintaining the posture of the test article when the holder releases the test article.

4. A drop test apparatus for performing a drop impact test by dropping an article to be tested on a landing surface in a free fall state, comprising:
a rebound prevention means having a grasp unit for grasping in the air the test article that collides with a landing surface and leaps up.

5. A drop test apparatus according to claim 4, wherein the grasp unit has impact absorbing means for absorbing the impact of the test article when the test article is grasped.

6. A drop test apparatus according to claim 1, which further comprises a rebound prevention means having a grasp unit for grasping in the air the test article that collides with a landing surface and leaps up.

7. A drop test apparatus according to claim 2, wherein the holder comprises a holding unit for holding the test article, and a posture maintenance unit for maintaining the posture of the test article when the holder releases the test article.
